(19) United States
(12) Patent Application Publication
(10) Pub. No.: US 2021/0291130 A1
(43) Pub. Date: Sep. 23, 2021

(54) Fluid Injection System

(71) Applicant: Miles Allen Watson, Grand Junction, CO (US)

(72) Inventor: Miles Allen Watson, Grand Junction, CO (US)

(21) Appl. No.: 17/210,470

(22) Filed: Mar. 23, 2021

Related U.S. Application Data
(60) Provisional application No. 62/993,175, filed on Mar. 23, 2020.

(51) Int. Cl. B01F 13/10; B01F 5/04; B01F 15/02; B01F 15/00

(52) U.S. Cl. CPC B01F 13/1055; B01F 5/0471; B01F 15/0243; B01F 15/026; B01F 15/00974; B01F 2215/0009; B01F 15/00149; B01F 15/00993; B01F 15/00305; B01F 5/0413; B01F 15/00344; B01F 15/00162

(57) ABSTRACT

A fluid injection system is a system that enables the automatic mixing and dispensing of select additives to desired output locations. The system may include at least one supply line, at least one pumping mechanism, at least one injection assembly, and a base controller. The at least one supply line carries the supply flow from a supply source for the mixing and the distribution of the selected additives to the desired output locations. The at least one pumping mechanism facilitates the injection of the additives to the supply flow being carried by the at least one supply line. The at least one injection assembly enables the introduction of the combined additives into the supply flow via the at least one pumping mechanism. Finally, the base controller monitors the injection of the right amounts of additives as well as the correct combination of the additives being injected into the supply flow.

The current application claims a priority to the U.S. provisional patent application Ser. No. 62/993,175 filed on Mar. 23, 2020.

### FIELD OF THE INVENTION

The present invention relates generally to fluid injection methods and delivery systems. More specifically, the present invention is a modular, unitized fluid injection system suitable for the mixing and delivery of select additives to desired output locations.

### BACKGROUND OF THE INVENTION

In general, fluid injection systems enable the introduction of different additives into a main fluid flow for mixing so that the main flow along with the additives are dispensed together. Various methods and mechanisms are currently available that enable users to inject one or more additives into a fluid to be dispensed to specific outlets, and many of these have been applied to different applications. For example, in the horticulture industry, there is often the need to treat different vegetation utilizing existing irrigation systems. The irrigation system enables a user to effectively manage a potentially unlimited area of vegetation by centralizing the control of the irrigation. Users can improve the quality of the vegetation under their care via the controlled introduction of various additive compounds to the irrigation system such as fertilizers, targeted defoliants, insecticides, and other chemicals understood to promote growth of the different vegetation. However, the measurement of these additives is often done in an ad hoc manner—as needed when needed. The lack of consistent treatment may leave some of the vegetation in a suboptimal condition compared to a constantly monitored and curated treatment regimen. Additionally, some additives are contraindicated for some of the vegetation within the same managed area, forcing the user to either risk harming one variety to aid another or manually disperse the additives to the corresponding vegetation. It is thusly considered that improvements to the treatment system are both possible and desirable, to be described herein.

An objective of the present invention is to provide a fluid injection system that allows the user to dispense specific amounts of additives into desired output locations. The present invention enables for the controlled dispensing of the specific amounts of additives at a specific time. Another objective of the present invention is to provide a control system with an integrated feedback system. A volumetric flow rate sensor is provided that allows the present invention to monitor real time the flow rate through the system. If the flow rate drops or increases outside a predetermined range, the system adjusts the injection of additives accordingly in real time. Another objective of the present invention is to enable the injection and simultaneous mixing of multiple additives to make desired mixed compounds. Another objective of the present invention is to provide a feedback system that enables continuous and remote monitoring. Multiple probes set in the desired output locations provide real time feedback that can be used by the control system to adjust the operation of the present invention. Further, the feedback system transmits real time data that be viewed and controlled by the user via a software application which can be installed on a phone, tablet, etc.

### SUMMARY OF THE INVENTION

The present invention provides a new and improved fluid injection system that enables the manual or automatic injection of select amounts of additives to be dispensed to target output locations. In one embodiment, the fluid injection system can be utilized with existing irrigation systems to systematically control the treatment of different vegetation. The present invention enables users to divide a managed area into smaller parcels of growth area which can be associated with individual irrigation outputs such as conventional sprinklers. The present invention also integrates a digitized control system into the routine treatment of said parcels, thus enabling a user to establish relatively complex treatment regimens without requiring constant supervision or manual intervention. The treatment regimens are done by the introduction of a modular array of additives that may be introduced to the managed area via controlled injection of the selected additives into the irrigation system that is regulated by the control system. The operation of the present invention further accounts for the needs of each individual parcel based on user preferences, enabling simultaneous disparate treatments to be carried out without constant supervision. Additional features and benefits of the present invention are further discussed in the sections below.

### BRIEF DESCRIPTION OF THE DRAWINGS

FIG. 1 is a schematic view showing the at least one supply line, the at least one pumping mechanism, and the at least one injection assembly.

FIG. 2 is a schematic diagram showing the electronic and the electrical connections of the base controller with different electrical and electronic components in the at least one supply line, the at least one pumping mechanism, and the at least one injection assembly.

FIG. 3 is a schematic view showing the fluid communication between the at least one supply line, the at least one pumping mechanism, the at least one injection assembly, and the plurality of dispensing valves.

FIG. 4 is a schematic view showing the electronic and the electrical connections of the base controller with the at least one valve controller, the plurality of dispensing valves, and the plurality of environmental-sensing probes.

FIG. 5 is a schematic view showing the wireless communication between the base controller, the plurality of environmental-sensing probes, and the electronic wireless device.

FIG. 6 is a perspective view showing an additive reservoir of the plurality of additive reservoirs, wherein the interchangeable bladder and line port are shown.

FIG. 7 is a magnified view of the bladder tap shown in FIG. 5, wherein the bladder-compatibility coupler is shown.

FIG. 8 is a schematic view showing the hermetic connection between the line port and the bladder tap by the bladder-compatibility coupler.

FIG. 9 is a schematic view showing the at least one supply line, the at least one pumping mechanism, and the at least one injection assembly, wherein the at least one pumping mechanism uses a venturi syphon.

FIG. 10 is a schematic view showing the fluid communication between the at least one supply line, the at least one pumping mechanism, the at least one injection assembly, and the plurality of dispensing valves, wherein the at least one pumping mechanism uses a venturi syphon.

### DETAIL DESCRIPTIONS OF THE INVENTION

All illustrations of the drawings are for the purpose of describing selected versions of the present invention and are not intended to limit the scope of the present invention.

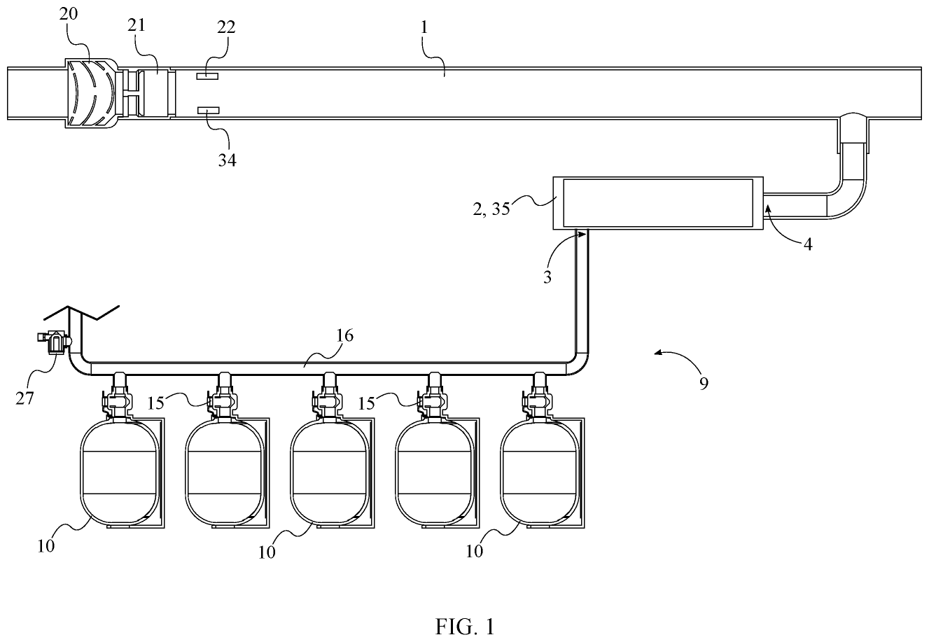

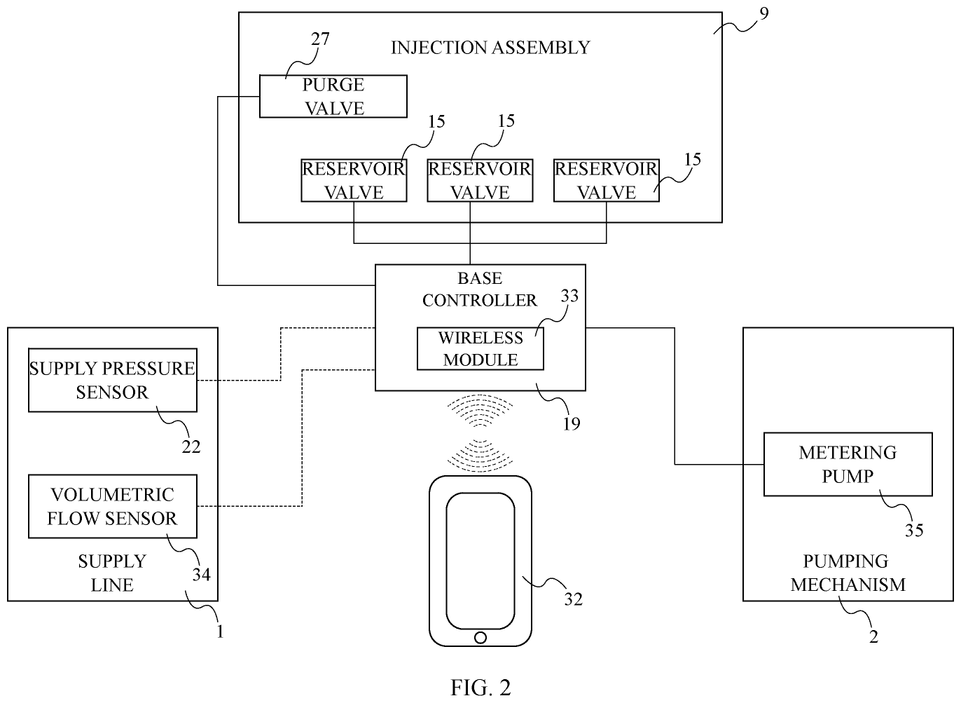

The present invention is a fluid injection system that enables the automatic mixing and dispensing of select additives to desired output locations. As can be seen in FIGS. 1 and 2, the present invention may comprise at least one supply line 1, at least one pumping mechanism 2, at least one injection assembly 9, and a base controller 19. The at least one supply line 1 carries the supply flow from a supply source for the mixing and the distribution of the selected additives to the desired output locations. The at least one pumping mechanism 2 facilitates the injection of the desired additives to the supply flow carried by the at least one supply line 1. The at least one injection assembly 9 enables the introduction of the selected additives into the supply flow via the at least one pumping mechanism 2. Further, the base controller 19 enables the automized delivery of the desired combination of additives to the correct output location. In addition, the base controller 19 enables the combination of the correct amount of the additives to be injected into the supply flow.

The general configuration of the aforementioned components enables the automated injection of additives into a supply flow in a controlled manner to be dispensed to select output locations. As can be seen in FIGS. 1 and 2, the at least one injection assembly 9 comprises a plurality of additive reservoirs 10, a plurality of reservoir valves 15, and an injection line 16. The plurality of additive reservoirs 10 contains the different additives to be injected into the supply fluid. The plurality of reservoir valves 15 enables the controlled injection of the additives from the plurality of additive reservoirs 10 into the injection line 16. The injection line 16 guides the different additives to be injected into the supply fluid flowing through the at least one pumping mechanism 2. Moreover, the injection line 16 is in fluid communication with the at least one supply line 1 through the at least one pumping mechanism 2 so that the at least one pumping mechanism 2 is able to drive the flow of injected additives from the injection line 16 to the at least one supply line 1. In addition, to facilitate the control of the type and the amount of the additives to be injected, each of the plurality of additive reservoirs 10 is in fluid communication with the injection line 16 by a corresponding reservoir valve from the plurality of reservoir valves 15. Thus, the type and the amount of the desired of additive can be controlled by opening the corresponding reservoir valve, enabling the injection of the additive from its additive reservoir, and then sealing the corresponding reservoir valve until future use. Finally, to facilitate the automatic operation of the system, the base controller 19 is electrically connected to each of the plurality of reservoir valves 15. Therefore, the base controller 19 can remotely and selectively engage each reservoir valve 15 to inject an appropriate amount and combination of the desired additives into the supply flow flowing through the at least one supply line 1. In one embodiment, the present invention can be applied to irrigation systems for different horticulture applications. For example, the present invention can be used to deliver different chemicals such as pesticides or fertilizers through the existing irrigation system to the growing vegetation. The at least one supply line 1 can be in fluid communication with the main line of the irrigation plumbing. In addition, the plurality of additive reservoirs 10 can include multiple additive reservoirs containing different pesticides, fertilizers, etc. Thus, when the irrigation system is engaged, the base controller 19 can engage the appropriate reservoir valve to enable the injection of the desired pesticide or fertilizer into the water flowing through the supply line and into the irrigation system. In other embodiments, the present invention can be integrated into different systems that require controlled injection of different additives into the system.

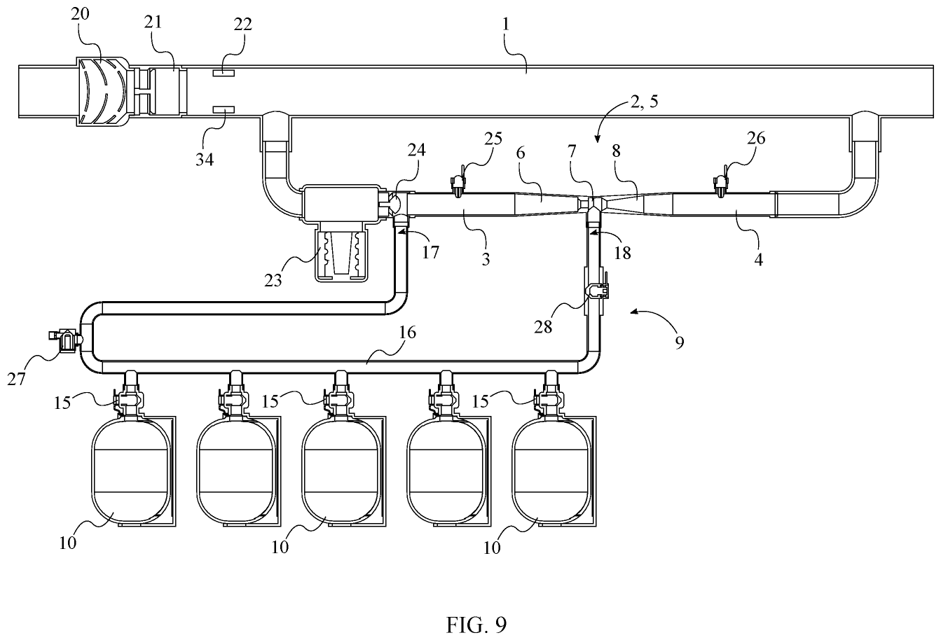

To prevent the contamination of the supply flow or the supply source, the present invention may further comprise at least one filter 20 and at least one backflow preventer 21, as can be seen in FIGS. 1 and 9. The at least one filter 20 prevents contaminants from flowing into the supply flow, while the at least one backflow preventer 21 minimizes the contamination of the supply source from the additives injected into the supply flow. The at least one filter 20 is operatively integrated into the at least one supply line 1 so that the at least one filter 20 is used to remove contaminants from fluid flow through the at least one supply line 1. For example, the at least one filter 20 can be a replaceable filter housed in a filter holder installed in the at least one supply line 1. Thus, the user can perform routine maintenance by replacing the at least one filter 20. Similarly, the at least one backflow preventer 21 is operatively integrated into the at least one supply line 1 so that the at least one backflow preventer 20 is used to remove one-way fluid flow through the at least one supply line 1. By forcing a one-way fluid flow through the at least one supply line 1, the at least one backflow preventer 21 ensures any injected additive flows away from the supply source. Further, the at least one filter 20, the at least one backflow preventer 21, and the at least one pumping mechanism 2 are in serial fluid communication with each other through the at least one supply line 1. Thus, as the fluid flows from the supply source, the fluid flows through the at least one filter 20, through the at least one backflow preventer 21, and through the rest of the at least one supply line 1, which is tapped by the at least one pumping mechanism 2. In addition, select additives can be injected into the supply flow along the at least one supply line 1. Therefore, the injected additives can be carried along the supply flow through the at least one supply line 1.

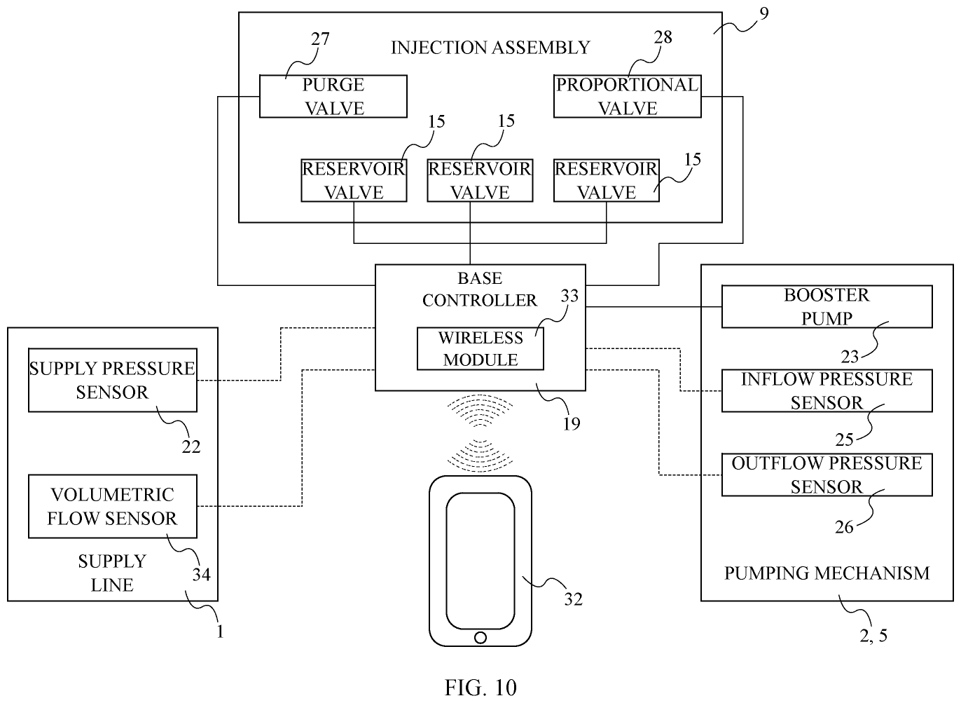

Furthermore, to ensure the proper fluid inflow pressure is present after the fluid has flowed through the at least one filter 20 and the at least one backflow preventer 21, the present invention may further comprise at least one supply pressure sensor 22. As can be seen in FIGS. 1 and 9, the at least one supply pressure sensor 22 is operatively integrated into the at least one supply line 1 so that the at least supply pressure sensor 22 is used to an internal pressure measurement within the at least one supply line 1. For example, the at least one supply pressure sensor 22 can be a transducer that generates electric signals corresponding to the different pressures imposed on the transducer. In addition, the at least one supply pressure sensor 22 is positioned in between the at least one backflow preventer 21 and the at least one pumping mechanism 2 along the at least one supply line 1. This position of the at least one supply pressure sensor 22 enables the remote monitoring of the flow pressure right after the fluid exits the at least one backflow preventer 21. Furthermore, the base controller 19 is electronically connected to the at least one supply pressure sensor 22, as can be seen in FIGS. 2 and 10. Thus, the inflow pressure of the at least one supply line 1 as the fluid exits the at least one backflow preventer 21 can be remotely monitored, and the user or the base controller 19 can take appropriate actions when the inflow pressure falls outside a predetermined range.

In addition to the at least one supply pressure sensor 22, the present invention may further comprise at least one volumetric flow sensor 34 to ensure the proper fluid inflow rate is present after the fluid has flowed through the at least one filter 20 and the at least one backflow preventer 21. As can be seen in FIGS. 1 and 9, the at least one volumetric flow sensor 34 is operatively integrated into the at least one supply line 1 so that the at least one volumetric flow sensor 34 is used to a volumetric flow rate measurement within the at least one supply line 1. For example, the at least one volumetric flow sensor 34 can measure the volumetric flow rate corresponding to the supply inflow to complement the measurements taken by the at least one supply pressure sensor 22. In addition, the at least one volumetric flow sensor 34 is positioned in between the at least one backflow preventer 21 and the at least one pumping mechanism 2 along the at least one supply line 1. This position of the at least one volumetric flow sensor 34 enables the remote monitoring of the flow rate right after the fluid exits the at least one backflow preventer 21. Furthermore, the base controller 19 is electronically connected to the at least one volumetric flow sensor 34, as can be seen in FIGS. 9 and 10. Thus, the inflow rate as the fluid exits the at least one backflow preventer 21 can be remotely monitored, and the user or the base controller 19 can take appropriate actions when the inflow rate falls outside a predetermined range.

Due to the physical and chemical properties of some of the additives contained within the plurality of additive reservoirs 10, the present invention may further comprise at least one purge valve 27 to trap any existing additive gases so that the additive gases may not flow back into the rest of the system, as can be seen in FIGS. 1, 2, 9, and 10. In addition, the at least one purge valve 27 also facilitates a cleanout cycle after every injection cycle to prevent leftover additives from the previous cycle to be dispensed in the new cycle or to prevent a vacuum from being formed within the plurality of additive reservoirs 10. The at least one purge valve 27 is operatively integrated into the injection line 16 so that the at least one purge valve 27 is used to remove gases from the injection line 16 as well as any leftover additives from the previous cycle. In addition, the at least one purge valve 27, the plurality of additive reservoirs 10, and the at least one pumping mechanism 2 are in serial fluid communication with each other through the injection line 16. Thus, any additive gases or fluids present in the injection line 16 are trapped or evacuated through the at least one purge valve 27 before the next cycle. Further, the base controller 19 is electrically connected to the at least one purge valve 27 to monitor the working conditions of the at least one purge valve 27 and to engage the at least one purge valve 27 at predetermined conditions.

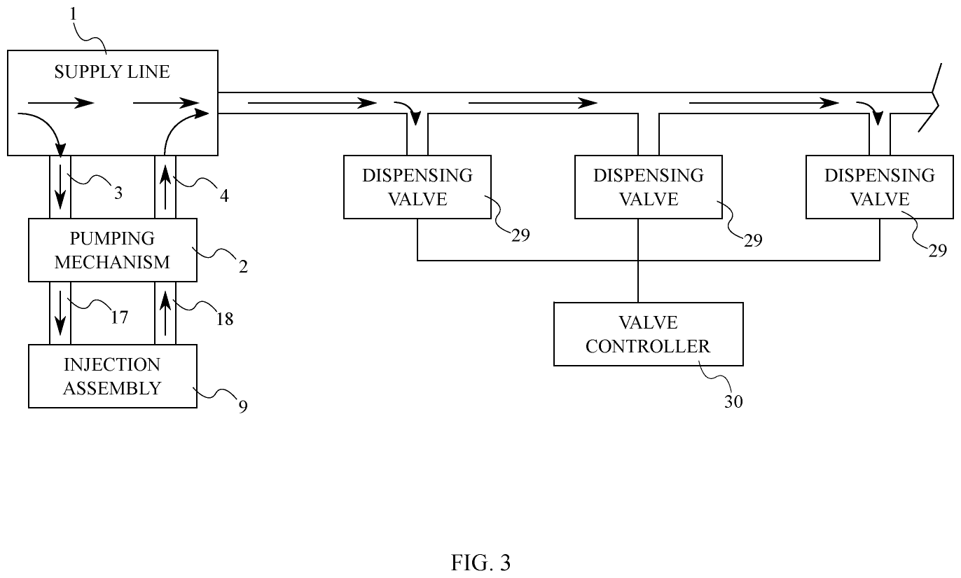

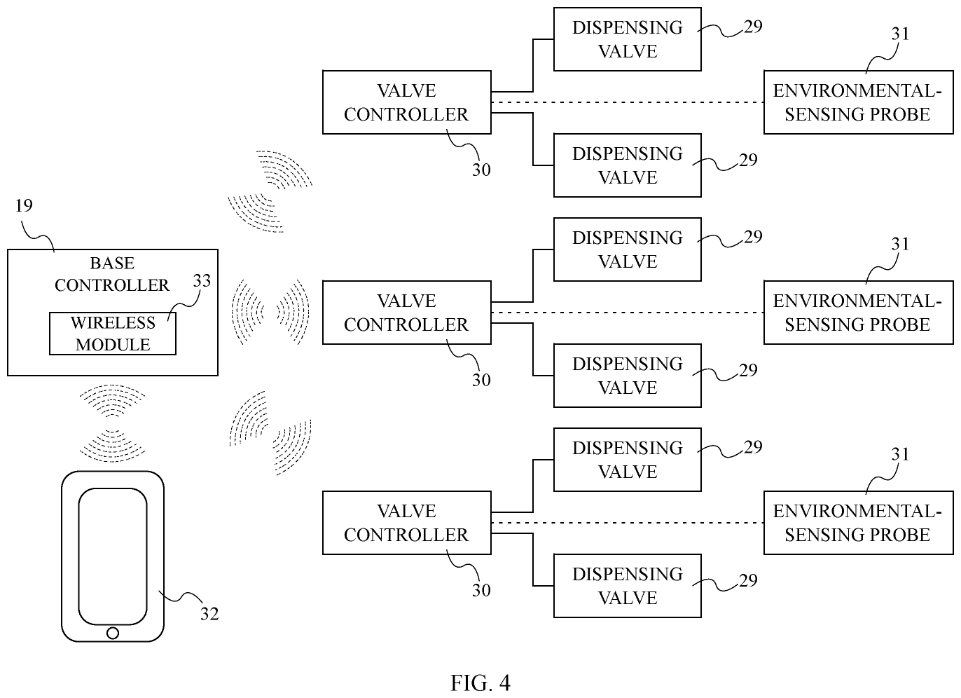

As previously discussed, the present invention also enables the controlled dispensing of the additives carried by the supply flow to select output locations as desired. To do so, the present invention may further comprise a plurality of dispensing valves 29 and at least one valve controller 30. As can be seen in FIGS. 3 and 4, the plurality of dispensing valves 29 enables the dispensing of the additives carried by the supply flow to select output locations. For example, in the irrigation system embodiment, selected fertilizers or pesticides may be dispensed to some vegetation but not to the whole vegetation as some of the chemicals used in the fertilizer/pesticides may be harmful to specific types of vegetation. The at least one valve controller 30 enables the remote monitoring and control of the plurality of dispensing valves 29 by the base controller 19. For example, the irrigation plumbing can reach a vast surface area, such as in farms, which can make it difficult for the base controller 19 to maintain continuous communication with the plurality of dispensing valves 29. Thus, the at least one valve controller 30 acts as the intermediary between the base controller 19 and the plurality of dispensing valves 29. The plurality of dispensing valves 29 and the at least one valve controller 30 is positioned offset from the at least one pumping mechanism 2 to accommodate output locations positioned far away from the base controller 19, the at least one injection assembly 9, and the base controller 19. As can be seen in FIGS. 3 and 4, the at least one pumping mechanism 2 and the plurality of dispensing valves 29 are in serial fluid communication with each other along the at least one supply line 1 so that the desired additives are directed to the desired dispensing valves. Further, the at least one valve controller 30 is electrically connected to each of the plurality of dispensing valves 29, allowing for one valve controller to monitor and control a group of dispensing valves corresponding to an area of the vegetation. The at least one valve controller 30 is also communicably coupled to the base controller 19 to transmit command signals from the base controller 19 to the plurality of dispensing valves 29. The base controller 19 may comprise a wireless module 33 that facilitates the wireless transmission of signals between the base controller 19 and the at least one valve controller 30. Therefore, the base controller 19 can monitor the operation of the plurality of dispensing valves 29 through the at least one valve controller 30 and send command signals to the at least one valve controller 30 which engages the desired plurality of dispensing valves 29.

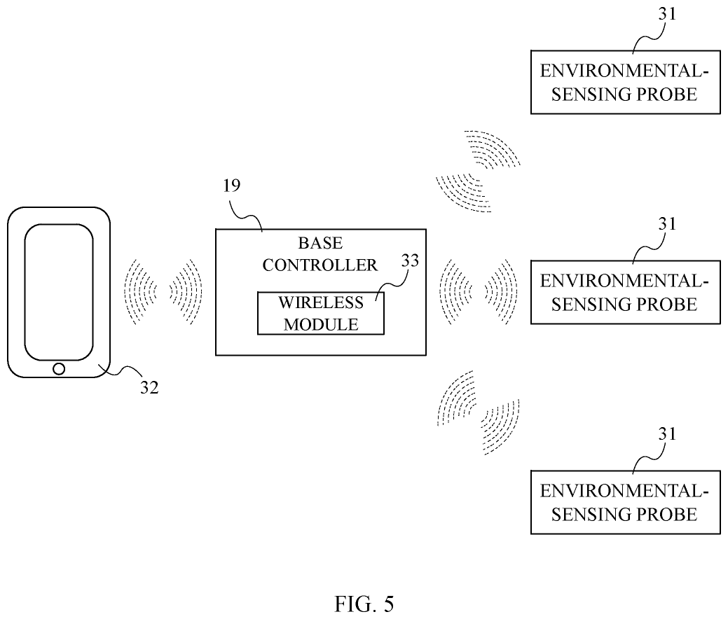

In addition to remotely monitoring and controlling the plurality of dispensing valves 29, the base controller 19 can also monitor different environmental variables in the different output locations to determine the additives that need to be dispensed to the output locations. To do so, the present invention may further comprise a plurality of environmental-sensing probes 31. As can be seen in FIGS. 4 and 5, the plurality of environmental-sensing probes 31 preferably includes multiple probes that can be distributed across the output locations so that base controller 19 can determine the appropriate additives that need to be dispensed according to the environment data measured by the plurality of environmental-sensing probes 31. For example, in the irrigation system embodiment, the plurality of environmental-sensing probes 31 can correspond to ground probes that measure the conditions of the soil and the growing vegetation. The plurality of environmental-sensing probes 31 is interspersed amongst the plurality of dispensing valves 29 to measure the environment conditions surrounding the corresponding dispensing valves. The environmental-sensing probes can measure different variables such as soil composition, moisture levels, etc. In addition, the plurality of environmental-sensing probes 31 is electronically connected to the at least one valve controller 30. Thus, the base controller 19 can monitor the conditions of the different output locations, determine the different additives that need to be dispensed to those output locations, and engage the at least one pumping mechanism 2, the at least one injection assembly 9, and the corresponding plurality of dispensing valves 29 to dispense the needed additives to the corresponding output locations. In other embodiments, each of the plurality of environmental-sensing probes 31 can be communicably coupled with the base controller 19 to directly transmit location data, such as soil conditions, weather conditions, vegetation conditions, etc.

Furthermore, the whole operation of the present invention can be monitored and controlled remotely by the user. As can be seen in FIGS. 2, 4, 5, and 10, the present invention may further comprise an electronic wireless device 32 through which the user can monitor the operation of the present invention, control the operation of the different electrical and electronic components, and configure the settings for the automatic operation of the whole system. The electronic wireless device 32 is communicably coupled to the base controller 19 so that operational data and command signals can be transmitted between the electronic wireless device 32 and the base controller 19. For example, in the irrigation system embodiment, the user can monitor the conditions of the growing vegetation via the plurality of environmental-sensing probes 31 as well as the status of the different components of the system. If there is an issue in the system, such as low supply inflow pressure, broken reservoir valve, etc. then the base controller 19 can transmit an error signal to the electronic wireless device 32 to alert the user. Further, the user can monitor the contents of the plurality of additive reservoirs 10, such as the current levels of additives, so that the user can perform any necessary maintenance, like replacing one the of additive reservoirs. The base controller 19 can also be communicably coupled to third-party services such as weather services to determine the appropriate operation of the system according to the data received from the third-party services. In other embodiments, the user can remotely monitor and control the system through different means, such as software applications with one or more servers that are communicably coupled to the base controller 19.

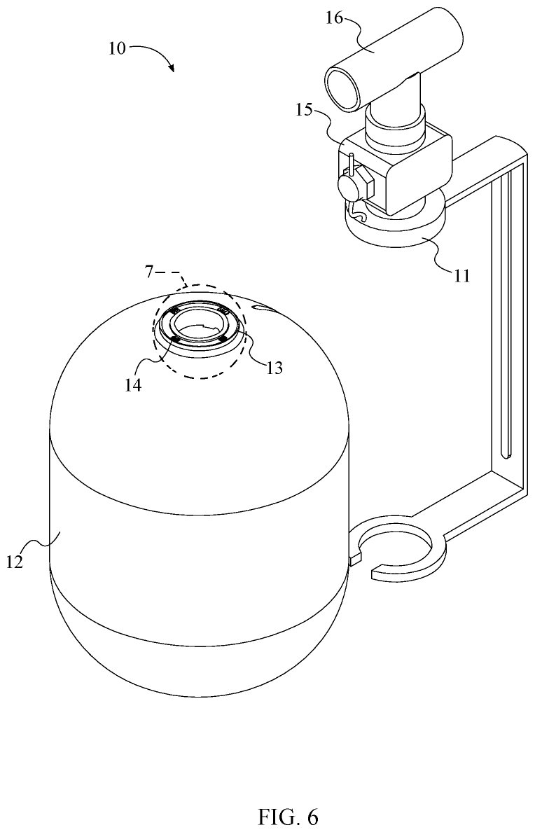

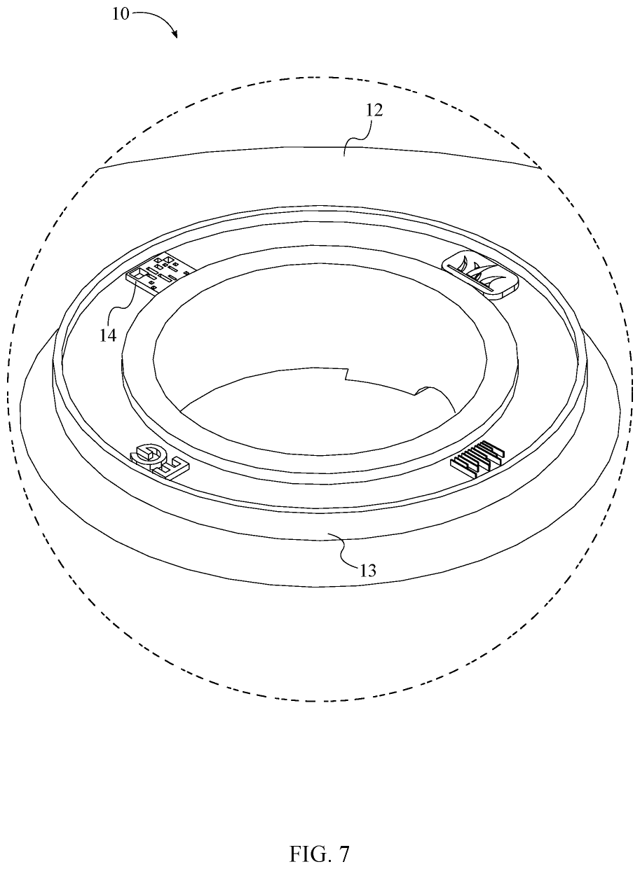

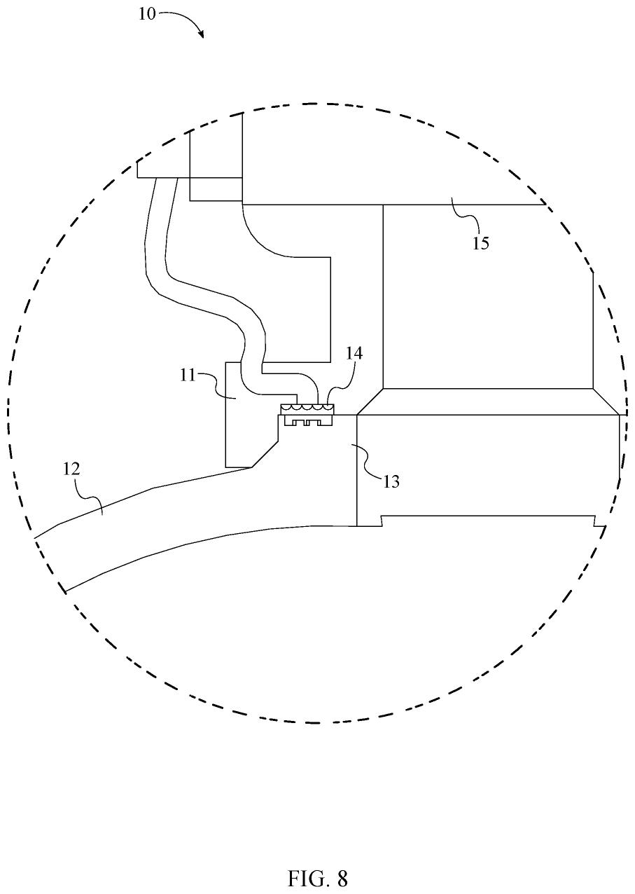

As previously discussed, the present invention minimizes the constant maintenance required by the system from the user to enable continuous automatic operation of the system. In some embodiments, each of the plurality of additive reservoirs 10 may comprise a line port 11 and an interchangeable bladder 12. As can be seen in FIG. 6 through 8, the line port 11 enables the user to replace the interchangeable bladder 12 when the interchangeable bladder 12 is depleted, or the contents have expired. The interchangeable bladder 12 enables the user to replenish the desired additive once the previous bladder has been used up with a new interchangeable bladder 12 containing the same or similar additives. The interchangeable bladder 12 also comprises a bladder tap 13 that facilitates the replacing of the interchangeable bladder 12. The line port 11 of each of the plurality of additive reservoirs 10 is in fluid communication with the corresponding reservoir valve of the plurality of reservoir valves 15 to control the flow of the additives from the interchangeable bladder 12 into the mixing line. This enables the base controller 19 to control the amount of the additive being injected into the injection line 16, further enabling the control of additives being injected into the supply flow via at least one pumping mechanism 2. For example, in the irrigation system embodiment, the base controller 19 can determine the additives needed by the vegetation and inject the appropriate amount of fertilizer, pesticide, etc. into the supply flow to be dispensed to the vegetation. Further, the bladder tap 13 is hermetically engaged the line port 11 to prevent any additive leaks. The base controller 19 can further monitor the additive levels within the interchangeable bladder 12 utilizing different means and alert the user when the interchangeable bladder 12 needs to be replaced. For example, the interchangeable bladder 12 can include a pressure sensor that is electronically connected to the corresponding reservoir valve. Thus, when the pressure within the interchangeable bladder 12 falls under a threshold, then the base controller 19 alerts the user that the interchangeable bladder 12 needs to be replaced.

Furthermore, to facilitate the replacement of the interchangeable bladder 12, each of the plurality of additive reservoirs 10 comprises a bladder-compatibility coupler 14. As can be seen in FIG. 6 through 8, the bladder-compatibility coupler 14 ensures that the correct interchangeable bladder 12 is connected to the appropriate line port 11. For example, in the irrigation system embodiment, the bladder-compatibility coupler 14 ensures that the user does not mistake the interchangeable bladder 12 containing fertilizer with the interchangeable bladder 12 containing pesticide. Further, the bladder-compatibility coupler 14 enables suppliers to ensure that the users only utilize an interchangeable bladder 12 provided by the supplier and not from third-party suppliers. The bladder tap 13 is hermetically engaged to the line port 11 by the bladder-compatibility coupler 14 so that, if the wrong interchangeable bladder 12 is being connected, then the user is unable to connect the bladder tap 13 to the line port 11. The bladder-compatibility coupler 14 may utilize different mechanisms and protocols to ensure the compatibility of the interchangeable bladder 12 with the system. For example, the bladder-compatibility coupler 14 can be a radio-frequency identification (RFID) system including a RFID reader and RFID tag. Alternatively, the bladder-compatibility coupler 14 can be an image recognition system or barcode system including an image scanner and an identifier or a barcode. The identifier can be specific indicia or graphics provided on the bladder tap 13 that identify the contents of the interchangeable bladder 12. The barcode can be the traditional graphic barcodes or new types of barcodes such as quick response (QR) codes. In other embodiments, the bladder-compatibility coupler 14 can utilize different means that enable the system to determine the compatibility of the interchangeable bladder 12 with the present invention.

In addition to the control of the plurality of reservoir valves 15, the base controller 19 can also control the operation of the at least one pumping mechanism 2 so that the injection of the additives can be synchronized with the conditions of the supply flow. As can be seen in FIGS. 1 and 2, the at least one pumping mechanism 2 is preferably a metering pump 35 able to provide an accurate volumetric flow rate of the additives to be injected into the supply flow. Further, the base controller 19 is also electronically connected to the metering pump 35 so that the base controller 19 can monitor and control the operation of the metering pump 35. Thus, together with the plurality of reservoir valves 15, the base controller 19 ensures the correct combination and the amounts of additives to be injected into the supply flow within the at least one supply line 1 which is then dispensed to the target output locations. Furthermore, with the input from the plurality of environmental-sensing probes 31, the at least one supply pressure sensor 22, and the at least one volumetric flow sensor 34, the base controller 19 can engage the metering pump 35 to accordingly deliver the appropriate additives to the correct output locations. For example, in the irrigation system embodiment, the base controller 19 can determine the appropriate fertilizers, pesticides, etc. to be delivered to the vegetation that need them from the plurality of environmental-sensing probes 31, engage the corresponding reservoir valves to inject the appropriate additives, and engage the metering pump 35 to accurately deliver the right amounts of additives to be injected into the at least one supply line 1. The metering pump 35 operates according to the flow conditions of the supply flow as measured by the at least one supply pressure sensor 22 and the at least one volumetric flow sensor 34.

In another embodiment, the at least one pumping mechanism 2 may utilize mechanical means to regulate the injection of additives into the at least one supply line 1. As can be seen in FIGS. 9 and 10, the at least one pumping mechanism 2 may comprise a pump inlet 3, a venturi syphon 5, and a pump outlet 4. The pump inlet 3 and the pump outlet 4 enable the flow of a portion of the supply flow through the venturi syphon 5, while the venturi syphon 5 enables the injection of the select additives to the supply flow using the venturi effect. The venturi syphon 5 comprises a convergent portion 6, a throat portion 7, and a divergent portion 8. The convergent portion 6 compresses the fluid until the fluid reaches the throat portion 7. The throat portion 7 corresponds to the narrowest portion of the venturi syphon 5 and guides the fluid into the divergent portion 8. The divergent portion 8 expands the fluid until the fluid reaches the pump outlet 4, where the fluid flows back into the supply flow of the at least one supply line 1. Further, the injection line 16 comprises a line inlet 17 and a line outlet 18. The line inlet 17 enables a partial flow from the fluid flowing through the venturi syphon 5 into the injection line 16. The line outlet 18 enables the partial flow along with the injected additives flowing through the injection line 16 to flow back into the venturi syphon 5.

As can be seen in FIGS. 9 and 10, the at least one supply line 1 is in parallel fluid communication with the venturi syphon 5 by the pump inlet 3 and the pump outlet 4 so that a portion of the supply flow flows from the at least one supply line 1, through the venturi syphon 5, and back into the at least one supply line 1. The pump inlet 3, the convergent portion 6, the throat portion 7, the divergent portion 8, and the pump outlet 4 are in serial fluid communication with each other to enable the fluid flow through the whole venturi syphon 5. The line inlet 17 is in fluid communication with the pump inlet 3 to redirect some of the fluid flowing through the at least one pumping mechanism 2 into the injection line 16 before getting to the venturi syphon 5. The line outlet 18 is in fluid communication with the throat portion 7 to direct the fluids flowing through the injection line 16 back into the venturi syphon 5. Further, each of the plurality of additive reservoirs 10 is in fluid communication with the injection line 16 by a corresponding reservoir valve from the plurality of reservoir valves 15. The plurality of reservoir valves 15 is preferably multiple electrically controlled valves, such as solenoid valves, which can be remotely engaged to enable the controlled flow of the additives from the plurality of reservoir valves 15 into the injection line 16. Also, the plurality of additive reservoirs 10 can contain different types of additives. This allows for the control of the type of additive and amount of the additives to be injected into the injection line 16 which then flow into the venturi syphon 5. The injection of the additives through the injection line 16 and into the venturi syphon 5 is facilitated by the pressure differential created by the venturi effect of the venturi syphon 5. Then, due to the parallel fluid communication, the fluid along with the injected additives constituting the outflow of the venturi syphon 5 flow back into the supply flow being carried by the at least one supply line 1, which is then distributed to the desired output locations.

In situations where the pressure of the supply inflow is not strong enough to divert the necessary amount of fluid to the venturi syphon 5, the present invention may further comprise at least one booster pump 23 and at least one check valve 24. As can be seen in FIGS. 9 and 10, the at least one booster pump 23 ensures enough fluid from the supply flow is diverted into the venturi syphon 5. Like the at least one backflow preventer 21, the at least one check valve 24 allows only for one-way flow through the venturi syphon 5, thus preventing turbulences from happening near the pump inlet 3. The at least one booster pump 23 is operatively integrated into the pump inlet 3 so that the at least one booster pump 23 is used to control an inflow pressure of the venturi syphon 5. Moreover, the at least one check valve 24 is operatively integrated into the pump inlet 3 so that the at least one check valve 24 is used to only allow one-way fluid flow through the venturi syphon 5. In addition, the at least one booster pump 23, the at least one check valve 24, and the convergent portion 6 are in serial fluid communication through the pump inlet 3. Thus, the fluid flow generated by the at least one booster pump 23 is guided towards the convergent portion 6 through the pump inlet 3 and any backflow is prevented by the at least one check valve 24. Furthermore, the base controller 19 is electrically connected to the at least one booster pump 23. Thus, the base controller 19 can selectively engage the at least one booster pump 23 when the supply inflow pressure or the inflow rate is low as measured by the at least one supply pressure sensor 22 or the at least one volumetric flow sensor 34, respectively.

To better monitor the system conditions through the venturi syphon 5, the present invention may further comprise at least one inflow pressure sensor 25 and at least one outflow pressure sensor 26, as can be seen in FIGS. 9 and 10. The at least one inflow pressure sensor 25 and the at least one outflow pressure sensor 26 enable the monitoring of the pressure differential across the venturi syphon 5 to ensure that the system is working at efficient conditions and that there is no major pressure loss across the venturi syphon 5 due to inefficiencies throughout the venturi syphon 5. The at least one inflow pressure sensor 25 is operatively integrated into the pump inlet 3 so that the at least one inflow pressure sensor 25 is used to take an internal pressure measurement within the pump inlet 3. Similarly, the at least one outflow pressure sensor 26 is integrated into the pump outlet 4 to take another internal pressure measurement within the pump outlet 4. Like the at least one supply pressure sensor 22, the at least one inflow pressure sensor 25, and the at least one outflow pressure sensor 26 can each be a transducer that generates electric signals corresponding to the different pressures imposed on the transducer. Further, the base controller 19 is electronically connected to the at least one inflow pressure sensor 25 and the at least one outflow pressure sensor 26. Thus, pressure measurements within the pump inlet 3 and the pump outlet 4 can be continuously monitored by the base controller 19 to detect an inadequate pressure differential across the venturi syphon 5 and take appropriate actions, such as alerting the user or engaging the at least one booster pump 23.

Furthermore, to ensure seamless flow of the additives from the injection line 16 into the venturi syphon 5, the present invention may further comprise at least one proportional valve 28. As can be seen in FIGS. 9 and 10, the at least one proportional valve 28 is operatively integrated into the injection line 16 so that the at least one proportional valve 28 is used to match an outflow pressure within the injection line 16 to an internal pressure of the throat portion 7. In addition, the plurality of additive reservoirs 10, the at least one proportional valve 28, and the line outlet 18 are in serial fluid communication with each other through the injection line 16. Thus, the outflow pressure within the line outlet 18 matches the throat pressure within the throat portion 7 to prevent turbulent flow when the two flows mix within the throat portion 7, making the mixing of the two flows as smooth as possible. Furthermore, the base controller 19 is electrically connected to the at least one proportional valve 28 to remotely monitor the operation of the at least one proportional valve 28 and to engage the at least one proportional valve 28, as necessary. For example, if there is a loss of pressure through the injection line 16 or if there is a pressure build up within the line outlet 18, then the at least one proportional valve 28 modifies the outflow through line outlet 18 before the outflow reaches the throat portion 7. In other embodiments, the at least one pumping mechanism 2 can utilize different means to facilitate the controlled and metered injection of additives from the at least one injection assembly 9 into the supply flow running through the at least one supply line 1.

Although the invention has been explained in relation to its preferred embodiment, it is to be understood that many other possible modifications and variations can be made without departing from the spirit and scope of the invention.

What is claimed is:

1. A fluid injection system comprising:
at least one supply line;
at least one pumping mechanism;
at least one injection assembly;
a base controller;
the at least one injection assembly comprising a plurality of additive reservoirs, a plurality of reservoir valves, and an injection line;
the injection line being in fluid communication with the at least one supply line through the at least one pumping mechanism;
each of the plurality of additive reservoirs being in fluid communication with the injection line by a corresponding reservoir valve from the plurality of reservoir valves; and,
the base controller being electrically connected to each of the plurality of reservoir valves.

2. The fluid injection system as claimed in claim 1 comprising:
at least one filter;
at least one backflow preventer;
the at least one filter being operatively integrated into the at least one supply line, wherein the at least one filter is used to remove contaminants from fluid flow through the at least one supply line;
the at least one backflow preventer being operatively integrated into the at least one supply line, wherein the at least one backflow preventer is used to allow one-way fluid flow through the at least one supply line; and,
the at least one filter, the at least one backflow preventer, and the at least one pumping mechanism being in serial fluid communication with each other through the at least one supply line.

3. The fluid injection system as claimed in claim 2 comprising:
at least one supply pressure sensor;
the at least one supply pressure sensor being operatively integrated into the at least one supply line, wherein the at least one supply pressure sensor is used to take an internal pressure measurement within the at least one supply line;
the at least one supply pressure sensor being positioned in between the at least one backflow preventer and the at least one pumping mechanism along the at least one supply line; and,
the base controller being electronically connected to the at least one supply pressure sensor.

4. The fluid injection system as claimed in claim 2 comprising:
at least one volumetric flow sensor;
the at least one volumetric flow sensor being operatively integrated into the at least one supply line, wherein the at least one volumetric flow sensor is used to take a volumetric flow rate measurement within the at least one supply line;
the at least one volumetric flow sensor being positioned in between the at least one backflow preventer and the at least one pumping mechanism along the at least one supply line; and,
the base controller being electronically connected to the at least one volumetric flow sensor.

5. The fluid injection system as claimed in claim 1 comprising:
at least one purge valve;
the at least one purge valve being operatively integrated into the injection line, wherein the at least one purge valve is used to remove gases from the injection line;
the at least one purge valve, the plurality of additive reservoirs, and the at least one pumping mechanism being in serial fluid communication with each other through the injection line; and,
the base controller being electrically connected to the at least one purge valve.

6. The fluid injection system as claimed in claim 1 comprising:
a plurality of dispensing valves;
at least one valve controller;
the plurality of dispensing valves and the at least valve controller being positioned offset from the at least one pumping mechanism;
the at least one pumping mechanism and the plurality of dispensing valves being in serial fluid communication with each other through the at least one supply line;
the at least one valve controller being electrically connected to each of the plurality of dispensing valves; and,
the at least one valve controller being communicably coupled to the base controller.

7. The fluid injection system as claimed in claim 6 comprising:
a plurality of environmental-sensing probes;
the plurality of environmental-sensing probes being interspersed amongst the plurality of dispensing valves; and,
the plurality of environmental-sensing probes being electronically connected to the at least one valve controller.

8. The fluid injection system as claimed in claim 1 comprising:
an electronic wireless device; and,
the electronic wireless device being communicably coupled to the base controller.

9. The fluid injection system as claimed in claim 1 comprising:
each of the plurality of additive reservoirs comprising a line port and an interchangeable bladder;
the interchangeable bladder comprising a bladder tap;
the line port of each of the plurality of additive reservoirs being in fluid communication with the corresponding reservoir valve of the plurality of reservoir valves; and,
the bladder tap being hermetically engaged to the line port.

10. The fluid injection system as claimed in claim 9 comprising:
each of the plurality of additive reservoirs further comprising a bladder-compatibility coupler; and,
the bladder tap being hermetically engaged to the line port by the bladder-compatibility coupler.

11. The fluid injection system as claimed in claim 1 comprising:
the at least one pumping mechanism being a metering pump; and,
the base controller being electronically connected to the metering pump.

12. The fluid injection system as claimed in claim 1 comprising:
the at least one pumping mechanism comprising a pump inlet, a venturi syphon, and a pump outlet;
the venturi syphon comprises a convergent portion, a throat portion, and a divergent portion;
the injection line comprising a line inlet and a line outlet;
the at least one supply line being in parallel fluid communication with the venturi syphon by the pump inlet and the pump outlet;
the pump inlet, the convergent portion, the throat portion, the divergent portion, and the pump outlet being in serial fluid communication with each other;
the line inlet being in fluid communication with the pump inlet; and,
the line outlet being in fluid communication with the throat portion.

13. The fluid injection system as claimed in claim 12 comprising:
at least one booster pump;
at least one check valve;
the at least one booster pump being operatively integrated into the pump inlet, wherein the at least one booster pump is used to control an inflow pressure of the venturi syphon;
the at least one check valve being operatively integrated into the pump inlet, wherein the at least one check valve is used to allow one-way fluid flow through the venturi syphon;
the at least one booster pump, the at least one check valve, and the convergent portion being in serial fluid communication through the pump inlet; and,
the base controller being electrically connected to the at least one booster pump.

14. The fluid injection system as claimed in claim 12 comprising:
at least one inflow pressure sensor;
at least one outflow pressure sensor;
the at least one inflow pressure sensor being operatively integrated into the pump inlet, wherein the at least one inflow pressure sensor is used to is used to take an internal pressure measurement within the pump inlet;
the at least one outflow pressure sensor being operatively integrated into the pump outlet, wherein the at least one outflow pressure sensor is used to is used to take another internal pressure measurement within the pump outlet; and,
the base controller being electronically connected to the at least one inflow pressure sensor and the at least one outflow pressure sensor.

15. The fluid injection system as claimed in claim 12 comprising:
at least one proportional valve;
the at least one proportional valve being operatively integrated into the injection line, wherein the at least one proportional valve is used to match an outflow pressure within the injection line to an internal pressure of the throat portion;
the plurality of additive reservoirs, the at least one proportional valve, and the line outlet being in serial fluid communication with each other through the injection line; and,
the base controller being electrically connected to the at least one proportional valve.

16. A fluid injection system comprising:
at least one supply line;
at least one pumping mechanism;
at least one injection assembly;
a base controller;
a plurality of dispensing valves;
at least one valve controller;
a plurality of environmental-sensing probes;
the at least one injection assembly comprising a plurality of additive reservoirs, a plurality of reservoir valves, and an injection line;
the injection line being in fluid communication with the at least one supply line through the at least one pumping mechanism;
each of the plurality of additive reservoirs being in fluid communication with the injection line by a corresponding reservoir valve from the plurality of reservoir valves;
the plurality of dispensing valves and the at least valve controller being positioned offset from the at least one pumping mechanism;
the at least one pumping mechanism and the plurality of dispensing valves being in serial fluid communication with each other through the at least one supply line;
the plurality of environmental-sensing probes being interspersed amongst the plurality of dispensing valves;
the base controller being electrically connected to each of the plurality of reservoir valves;
the at least one valve controller being electrically connected to each of the plurality of dispensing valves;
the at least one valve controller being communicably coupled to the base controller; and,
the plurality of environmental-sensing probes being electronically connected to the at least one valve controller.

17. The fluid injection system as claimed in claim 16 comprising:
at least one filter;
at least one backflow preventer;
at least one supply pressure sensor;
at least one volumetric flow sensor;
the at least one filter being operatively integrated into the at least one supply line, wherein the at least one filter is used to remove contaminants from fluid flow through the at least one supply line;
the at least one backflow preventer being operatively integrated into the at least one supply line, wherein the at least one backflow preventer is used to allow one-way fluid flow through the at least one supply line;
the at least one filter, the at least one backflow preventer, and the at least one pumping mechanism being in serial fluid communication with each other through the at least one supply line;
the at least one supply pressure sensor being operatively integrated into the at least one supply line, wherein the at least one supply pressure sensor is used to take an internal pressure measurement within the at least one supply line;
the at least one volumetric flow sensor being operatively integrated into the at least one supply line, wherein the at least one volumetric flow sensor is used to take a volumetric flow rate measurement within the at least one supply line;
the at least one supply pressure sensor being positioned in between the at least one backflow preventer and the at least one pumping mechanism along the at least one supply line;
the at least one volumetric flow sensor being positioned in between the at least one backflow preventer and the at least one pumping mechanism along the at least one supply line; and,
the base controller being electronically connected to the at least one supply pressure sensor and the at least one volumetric flow sensor.

18. The fluid injection system as claimed in claim 16 comprising:
at least one purge valve;
each of the plurality of additive reservoirs comprising a line port, an interchangeable bladder, and a bladder-compatibility coupler;
the interchangeable bladder comprising a bladder tap;
the at least one purge valve being operatively integrated into the injection line, wherein the at least one purge valve is used to remove gases from the injection line;
the at least one purge valve, the plurality of additive reservoirs, and the at least one pumping mechanism being in serial fluid communication with each other through the injection line;
the base controller being electrically connected to the at least one purge valve;
the line port of each of the plurality of additive reservoirs being in fluid communication with the corresponding reservoir valve of the plurality of reservoir valves; and,
the bladder tap being hermetically engaged to the line port by the bladder-compatibility coupler.

19. The fluid injection system as claimed in claim 16 comprising:
at least one booster pump;
at least one check valve;
the at least one pumping mechanism comprising a pump inlet, a venturi syphon, and a pump outlet;
the venturi syphon comprises a convergent portion, a throat portion, and a divergent portion;
the injection line comprising a line inlet and a line outlet;
the at least one supply line being in parallel fluid communication with the venturi syphon by the pump inlet and the pump outlet;
the pump inlet, the convergent portion, the throat portion, the divergent portion, and the pump outlet being in serial fluid communication with each other;
the line inlet being in fluid communication with the pump inlet;
the line outlet being in fluid communication with the throat portion;
the at least one booster pump being operatively integrated into the pump inlet, wherein the at least one booster pump is used to control an inflow pressure of the venturi syphon;
the at least one check valve being operatively integrated into the pump inlet, wherein the at least one check valve is used to allow one-way fluid flow through the venturi syphon;
the at least one booster pump, the at least one check valve, and the convergent portion being in serial fluid communication through the pump inlet;
and,
the base controller being electrically connected to the at least one booster pump.

20. The fluid injection system as claimed in claim 19 comprising:
at least one inflow pressure sensor;
at least one outflow pressure sensor;
at least one proportional valve;
the at least one inflow pressure sensor being operatively integrated into the pump inlet, wherein the at least one inflow pressure sensor is used to is used to take an internal pressure measurement within the pump inlet;
the at least one outflow pressure sensor being operatively integrated into the pump outlet, wherein the at least one outflow pressure sensor is used to is used to take another internal pressure measurement within the pump outlet;
the at least one proportional valve being operatively integrated into the injection line, wherein the at least one proportional valve is used to match an outflow pressure within the injection line to an internal pressure of the throat portion;
the plurality of additive reservoirs, the at least one proportional valve, and the line outlet being in serial fluid communication with each other through the injection line;
the base controller being electronically connected to the at least one inflow pressure sensor and the at least one outflow pressure sensor; and,
the base controller being electrically connected to the at least one proportional valve.
